(19) United States
(12) Patent Application Publication
(10) Pub. No.: US 2018/0229383 A1
(43) Pub. Date: Aug. 16, 2018

(54) ELECTRIC SHAVER AND OUTER BLADE USED IN THE ELECTRIC SHAVER

(71) Applicant: PANASONIC INTELLECTUAL PROPERTY MANAGEMENT CO., LTD., Osaka (JP)

(72) Inventors: Shintaro MATSUO, Shiga (JP); Shigetoshi SAKON, Osaka (JP); Kenji NARITA, Osaka (JP)

(21) Appl. No.: 15/886,367

(22) Filed: Feb. 1, 2018

(30) Foreign Application Priority Data
Feb. 10, 2017 (JP) 2017-023233

(51) Int. Cl. B26B 19/38; B26B 19/10; B26B 19/04; B26B 19/14

(52) U.S. Cl. CPC B26B 19/3846; B26B 19/146; B26B 19/042; B26B 19/10

(57) ABSTRACT

An outer blade for an electric shaver has slits. With bars extending along an outer-blade width direction, each of the slits is defined by respective ends of the bars, the respective ends being positioned side by side along an outer-blade length direction, and is defined continuously from one end to another end in the outer-blade width direction. At least one of two bars that define the slit is provided with a lifter that lifts hair by contact. The lifter is formed partway along the slit and extends between edges of the slit along the outer-blade length direction when viewed along the outer-blade width direction.

### BACKGROUND

### 1. Technical Field

The present disclosure relates to an electric shaver and an outer blade used in the electric shaver.

### 2. Description of the Related Art

As disclosed in Japanese Patent No. 4,140,558, a conventionally known electric shaver includes outer blades that are held to a main body, and inner blades that are respectively disposed inwardly of the outer blades to be movable relatively to the respective outer blades.

In the disclosure of Japanese Patent No. 4,140,558, the outer slit blade having slits that are slender along a shaving direction is provided, thereby enabling efficient shaving of relatively long hair.

A bar disposed between the slits has such a shape that straight bar parts are connected by an intermediate crooked bar part, so that when the outer slit blade is viewed in the shaving direction, the slit lies in an increasing area. Thus, as the outer slit blade abutting skin is slid in the shaving direction, a region of skin facing the slit can be increased, whereby hair is shaved efficiently.

### SUMMARY

While the conventional technique also enables efficient hair shaving, it is preferable that hair be shaved more efficiently.

The present disclosure provides an electric shaver that can shave hair more efficiently, and an outer blade that is used in the electric shaver.

The electric shaver of the present disclosure includes the outer blade that has a predetermined length and a predetermined width and makes contact with skin, and an inner blade that is disposed on an opposite side of the outer blade from a skin contact side of the outer blade and shifts relatively to the outer blade.

The outer blade is provided with a plurality of bars that extend along an outer-blade width direction and are arranged at predetermined intervals along an outer-blade length direction.

A slit into which hair is introduced is defined, between two of the bars that are adjacent along the outer-blade length direction, by respective ends of the two bars, the respective ends being positioned side by side along the outer-blade length direction. The slit is continuously defined from one end to another end in the outer-blade width direction.

At least one of the two bars is provided with a lifter that lifts, by contact, the hair that is introduced into the slit as the outer blade is moved relatively to the hair along the outer-blade width direction.

The lifter is formed partway along the slit and extends between edges of the slit along the outer-blade length direction when viewed along the outer-blade width direction.

The outer blade of the present disclosure is used in the electric shaver.

According to the present disclosure, when the outer blade is moved along the outer-blade width direction with flat-lying hair introduced into the slit, the flat-lying hair can be brought into abutment with the lifter, thereby being lifted (raised). In other words, the flat-lying hair is raised and thus can be introduced even further toward the inner blade from a surface of contact between the inner blade and the outer blade. The electric shaver that can be obtained can thus shave hair more efficiently, and the outer blade that is used in the electric shaver can be obtained.

### BRIEF DESCRIPTION OF THE DRAWINGS

FIG. 1 is a front view of an electric shaver according to an exemplary embodiment of the present disclosure;

FIG. 2 is a front view of the electric shaver according to the exemplary embodiment of the present disclosure, illustrating an outer-blade cassette and an outer-blade holding member that are included in a detached outer-blade block in a disassembled state;

FIG. 3 is a plan view of outer blades of the electric shaver according to the exemplary embodiment of the present disclosure;

FIG. 4 is an enlarged sectional view of the outer slit blade and an inner slit blade according to the exemplary embodiment of the present disclosure;

FIG. 5 is a plan view of the outer slit blade according to the exemplary embodiment of the present disclosure;

FIG. 6A is an enlarged view of part A in FIG. 5;

FIG. 6B is a perspective sectional view taken along line 6B-6B of FIG. 6A;

FIG. 6C is a sectional view taken along line 6C-6C of FIG. 6A;

FIG. 7 is a plan view of an outer slit blade in a first modification of the exemplary embodiment of the present disclosure;

FIG. 8A is an enlarged view of part B in FIG. 7;

FIG. 8B is a perspective sectional view taken along line 8B-8B of FIG. 8A;

FIG. 8C is a sectional view taken along line 8C-8C of FIG. 8A;

FIG. 9 is a plan view of an outer slit blade in a second modification of the exemplary embodiment of the present disclosure;

FIG. 10A is an enlarged view of part C in FIG. 9;

FIG. 10B is a perspective sectional view taken along line 10B-10B of FIG. 10A;

FIG. 10C is a sectional view taken along line 10C-10C of FIG. 10A; and

FIG. 11 is a sectional view illustrating an outer slit blade provided with hair raising parts according to the exemplary embodiment of the present disclosure.

### DETAILED DESCRIPTION

An exemplary embodiment of the present disclosure is hereinafter described with reference to the drawings. It is to be noted that this exemplary embodiment is not restrictive of the present disclosure.

Hereinafter, a direction in which a plurality of outer blades are arranged side by side is described as front-back direction (shaving direction) X, a direction in which the outer blades each extend is described as left-right direction Y, while an upwardly facing direction of the outer blades in a disposed outer-blade block (a head section) is described as up-down direction Z. A switch side of an electric shaver is described as a front side in front-back direction X.

Front-back direction X, left-right direction Y, and up-down direction Z are also used to describe respective directions of the outer slit blade. In other words, with the outer slit blade being mounted to a head section body, directions that respectively agree with front-back direction X, left-right direction Y, and up-down direction Z of the outer-blade block are defined as front-back direction X, left-right direction Y, and up-down direction Z of the outer slit blade, respectively.

### Exemplary Embodiment

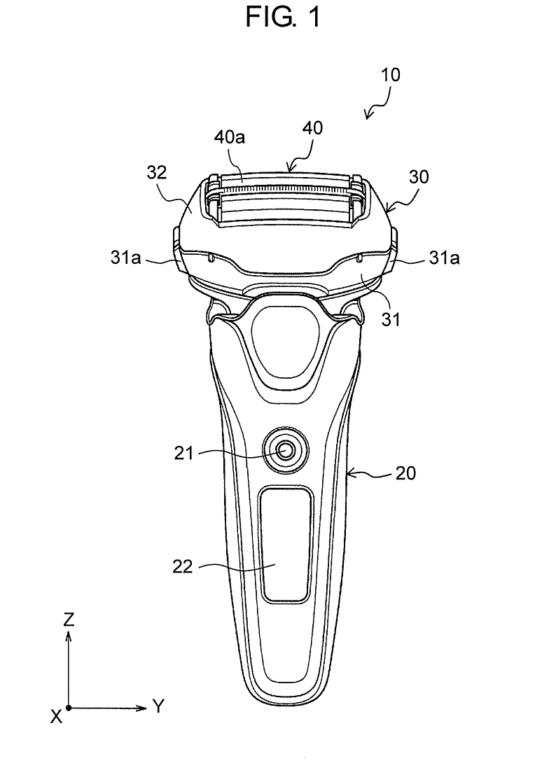

As shown in FIG. 1, electric shaver 10 according to the present exemplary embodiment includes grip section 20 that is gripped by a hand, and head section 30 that is supported by grip section 20.

Grip section 20 is provided with push switch 21 that activates (turns on and off power to) electric shaver 10. It is to be noted that while push switch 21 is shown as an example of the switch in the present exemplary embodiment, the switch has only to turn on and off power and thus may be a slide switch or a switch of another type.

In the present exemplary embodiment, switch 21 is formed at a front face of grip section 20, that is, at a front (forward) face of electric shaver 10. It is to be noted that the front face of electric shaver 10 is a face that faces a user when grip section 20 of electric shaver 10 is gripped by the user in normal use.

In the present exemplary embodiment, grip section 20 is provided with, below switch 21, display 22 that displays, for example, a state of charge of a secondary battery (not shown) included in grip section 20.

It is to be noted that a trimmer unit can be provided at a rear of grip section 20 (or electric shaver 10).

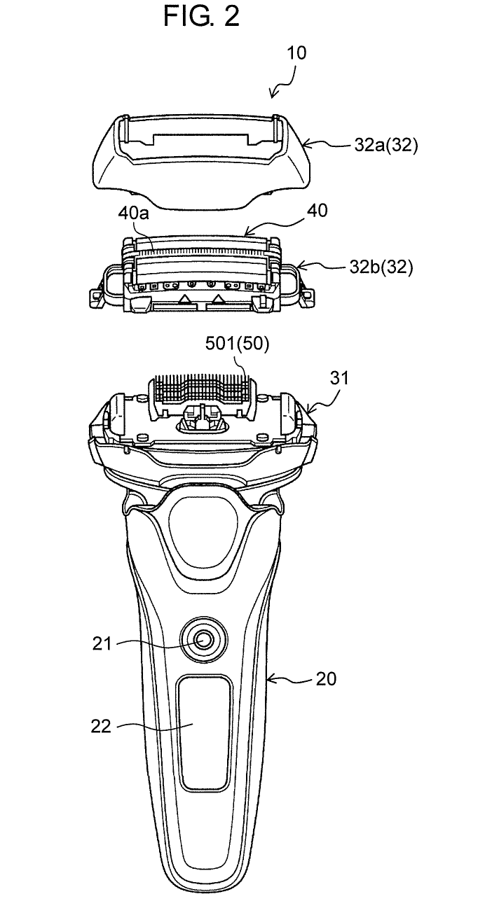

As shown in FIGS. 1 and 2, head section 30 includes head section body 31 that is mounted to grip section 20, and outer-blade block 32 that is detachably mounted to head section body 31. In the present exemplary embodiment, as release buttons 31a that are respectively provided at a left and a right end of head section body 31 in a retractable manner are sank inward, outer-blade block 32 is detached from head section body 31.

Head section body 31 accommodates a drive mechanism that is not shown. Conventionally and publicly known examples of the drive mechanism that can be used include an oscillatory linear actuator and a drive mechanism that is formed of a rotary motor and a conversion mechanism that converts rotation to linear reciprocation.

As shown in FIG. 2, outer-blade block 32 includes outer-blade holding member 32a that is substantially tubular and is mounted with vertically movable (floatable) outer blades 40, and outer-blade cassette 32b of box shape that supports vertically movable outer blades 40. With outer-blade cassette 32b mounted to outer-blade holding member 32a, outer blades 40 are mounted to outer-blade holding member 32a in a vertically movable manner.

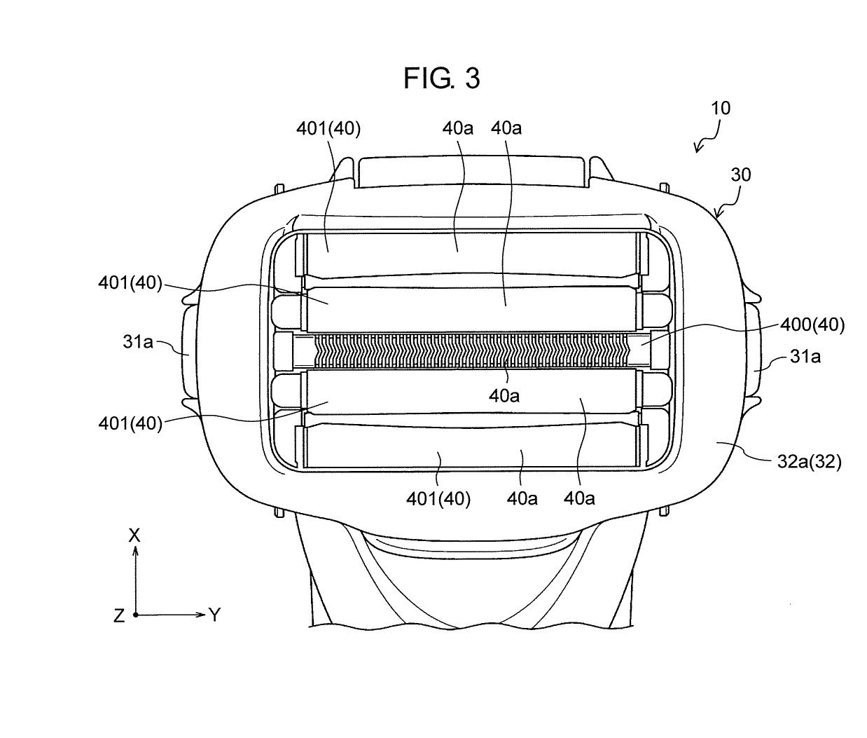

Here, outer blades 40 are disposed so as to be exposed upward in head section 30 as shown in FIGS. 1 and 3. An upwardly exposed part of outer blades 40 in head section 30 is skin contact face (surface) 40a that abuts skin (skin surface) S of the user. In the present exemplary embodiment, outer-blade cassette 32b is detachably mounted not only to outer-blade holding member 32a but also to head section body 31.

Here, the plurality of outer blades 40 that are arranged side by side along front-back direction X are supported by outer-blade cassette 32b (refer to FIG. 3).

Specifically, outer blades 40 include outer slit blade 400 and four outer net blades 401. Two outer net blades 401, outer slit blade 400, and two outer net blades 401 are arranged along front-back direction X.

Thus, with outer-blade cassette 32b mounted to outer-blade holding member 32a, two outer net blades 401, outer slit blade 400, and two outer net blades 401 are disposed in an upwardly exposed manner in outer-blade holding member 32a in this order from the front side in front-back direction X.

It is to be noted that FIG. 3 merely shows examples of the types of outer blade, the number of outer blades, and the arrangement of the outer blades. Thus, it goes without saying that the types of outer blade, the number of outer blades, and the arrangement of the outer blades can be appropriately changed.

When viewed from their side (along left-right direction Y), four outer net blades 401 are all formed so as to curve along front-back direction X to have an inverted U-shape with their respective upper portions protruding. When viewed from their front (along front-back direction X), outer net blades 401 are formed so as to slightly curve along left-right direction (outer-blade length direction) Y with their respective upper portions protruding. While outer net blades 401 are curved in the present exemplary embodiment to have the respective protrusive upper portions when viewed from their front, outer net blades 401 need not necessarily be curved.

Outer net blades 401 are each provided with, for example, a number of circular blade holes (not shown).

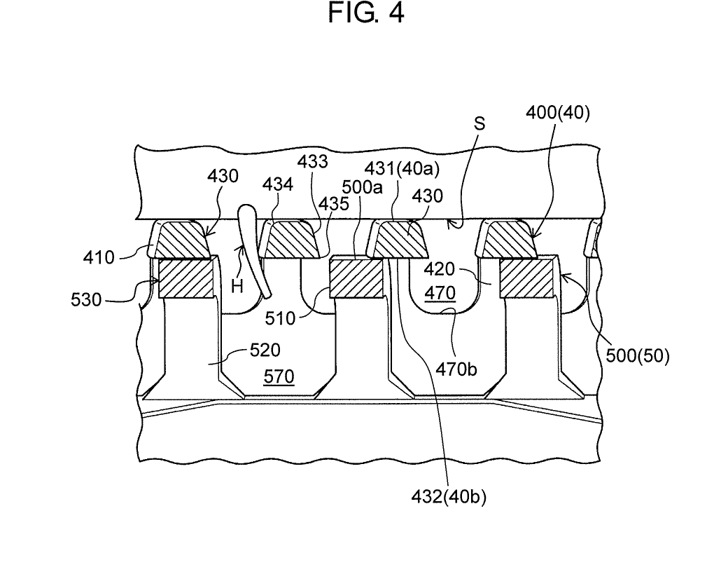

On the other hand, outer slit blade 400 is provided for shaving long hair H (refer to FIG. 4) that is difficult to shave with outer net blades 401, and is bent along front-back direction X to have a substantially squared U-shape. This outer slit blade 400 can be formed by use of, for example, a flat metal plate.

In the present exemplary embodiment, outer slit blade 400 is disposed to be narrow along front-back direction X and to be long along left-right direction Y and is of substantially inverted U-shaped cross section to be protrusive toward skin S (refer to FIG. 4). As such, outer slit blade 400 that makes contact with skin (skin surface) S has a predetermined length and a predetermined width in the present exemplary embodiment and is disposed with its outer-blade length direction substantially agreeing with left-right direction Y of electric shaver 10 and with its outer-blade width direction substantially agreeing with front-back direction X of electric shaver 10.

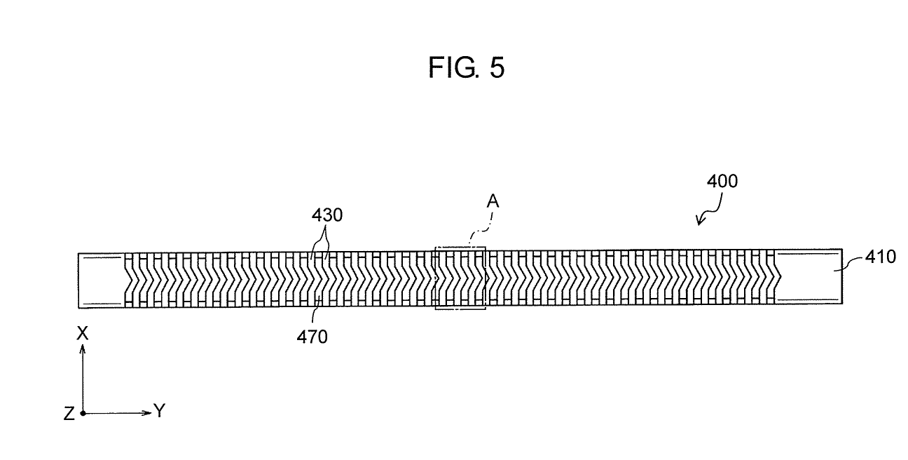

As shown in FIGS. 4 and 5, this outer slit blade 400 includes flat top wall 410 that faces skin (skin surface) S, and a pair of side walls 420, 420 that connects with top wall 410 at respective ends in front-back direction (outer-blade width direction) X, extends toward inner slit blade 500 (away from skin S) and faces each other along front-back direction X.

Outer slit blade 400 is formed by providing slits 470 (blade holes in outer blade 40) that are bored through flat top wall 410 and side walls 420. In other words, slits 470 are formed to extend from one of side walls 420 to the other one of side walls 420 along front-back direction X of outer slit blade 400.

Thus, each of slits 470 is slender, having a length and a width in the present exemplary embodiment. Slits 470 are formed with their length direction (slit length direction) substantially agreeing with the width direction (front-back direction X) of outer slit blade 400.

As such, slits 470 are formed with their length direction (slit length direction) substantially agreeing with front-back direction X of electric shaver 10 and with their width direction (slit width direction) substantially agreeing with left-right direction Y of electric shaver 10.

In the present exemplary embodiment, the plurality of slits 470 are arranged with substantially equal intervals at predetermined pitches (predetermined intervals) along left-right direction (outer-blade length direction: slit width direction) Y. Between adjacent slits 470, bar 430 is formed along slits 470, thus extending along front-back direction X. This means that outer slit blade 400 is provided with the plurality of bars 430 that extend along front-back direction (outer-blade width direction) X and are arranged with substantially equal intervals at predetermined pitches (predetermined intervals) along left-right direction (outer-blade length direction) Y, and each of slits 470 is such that its edges positioned side by side along left-right direction Y are respectively defined by two bars 430 positioned on its respective sides along left-right direction Y.

Also, bars 430 have their lengths and widths and are formed with their length direction (slit length direction) substantially agreeing with front-back direction X of electric shaver 10 and with their width direction (slit width direction) substantially agreeing with left-right direction Y of electric shaver 10. Bars 430 extend from flat top wall 410 to side walls 420 and have a substantially squared U-shape when viewed from their side.

In the present exemplary embodiment, slits 470 each have first slit end 470a and second slit end 470b that are formed in front-back direction (outer-blade width direction: slit length direction) X in respective side walls 420. With first slit end 470a and second slit end 470b of slit 470 thus formed in front-back direction (outer-blade width direction: slit length direction) X in respective side walls 420, slit 470 opens not only upward but also sideward. In this way, slits 470 are formed to extend from one end to another end of outer slit blade 400 along front-back direction X without being disconnected partway, whereby even relatively long hair H can be introduced into slit 470 with more ease. Moreover, increase in resistance (e.g., frictional force) of hair H that might be caused by hair H caught by bars 430 is suppressed, whereby degradation of shaving comfort can be suppressed.

Inner blades 50 mounted are respectively used exclusively for outer net blades 401 and outer slit blade 400 that are outer blades 40.

Specifically, inner blade 50 (inner blade 501 for outer net blade 401) having an inverted U-shape that skirts along corresponding outer net blade 401 of curved shape is disposed inwardly of corresponding outer net blade 401 (below corresponding outer net blade 401: on an opposite side of corresponding outer blade 40 from a skin S contact side of corresponding outer blade 40) (refer to FIG. 2).

On the other hand, inner slit blade 500 having a substantially squared U-shape that skirts along bent outer slit blade 400 is disposed inwardly of outer slit blade 400 (below outer slit blade 400: on an opposite side of corresponding outer blade 40 from a skin S contact side of corresponding outer blade 40) (refer to FIG. 4). Also this inner slit blade 500 can be formed by use of a flat metal plate.

Inner slit blade 500 is disposed to be narrow along front-back direction X and to be long along left-right direction Y and has a substantially inverted U-shaped cross section to be upwardly protrusive (toward skin S). As such, this inner slit blade 500 also has a predetermined length and a predetermined with and is disposed with its inner-blade length direction substantially agreeing with left-right direction Y of electric shaver 10 and with its inner-blade width direction substantially agreeing with front-back direction X of electric shaver 10. Moreover, inner slit blade 500 is formed to be one size smaller than outer slit blade 400.

As shown in FIG. 4, inner slit blade 500 includes flat top wall 510 that is provided with outer faces (sliding contact faces that makes sliding contact with outer slit blade 400) 500a, and a pair of side walls 520, 520 that connects with top wall 510 at the respective ends in front-back direction (inner-blade width direction) X, extends downward (in the direction away from skin 5) and faces each other along front-back direction X.

Inner slit blade 500 is formed by providing inner-blade slits 570 that are bored through flat top wall 510 and side walls 520. In other words, inner-blade slits 570 are formed to extend from one of side walls 520 to the other one of side walls 520 along front-back direction X of inner slit blade 500.

Thus, also each of inner-blade slits 570 of inner slit blade 500 is slender, having a length and a width in the present exemplary embodiment. These inner-blade slits 570 are formed with their length direction (slit length direction) substantially agreeing with the width direction (inner-blade width direction) of inner slit blade 500 (inner blade 50).

As such, inner-blade slits 570 are formed with their length direction (slit length direction) substantially agreeing with front-back direction X of electric shaver 10 and with their width direction (slit width direction) substantially agreeing with left-right direction Y of electric shaver 10.

In the present exemplary embodiment, the plurality of inner-blade slits 570 are arranged with substantially equal intervals at predetermined pitches (predetermined intervals) along left-right direction (inner-blade length direction) Y. Between adjacent inner-blade slits 570, bar 530 is formed along inner-blade slits 570, thus extending along front-back direction X. This means that inner slit blade 500 is provided with the plurality of bars 530 that extend along front-back direction (inner-blade width direction) X and are arranged with substantially equal intervals at predetermined pitches (predetermined intervals) along left-right direction (inner-blade length direction) Y, and each of inner-blade slits 570 is such that its edges positioned side by side along left-right direction Y are respectively defined by two bars 530 positioned on its respective sides along left-right direction Y.

Also, bars 530 have their lengths and widths and are formed with their length direction (slit length direction) substantially agreeing with front-back direction X of electric shaver 10 and with their width direction (slit width direction) substantially agreeing with left-right direction Y of electric shaver 10. Bars 530 extend from flat top wall 510 to side walls 520 and have a substantially squared U-shape when viewed from their side.

It is to be noted that in the present exemplary embodiment, the pitch intervals between inner-blade slits 570 are greater than the pitch intervals between slits 470. Also, each of inner-blade slits 570 has ends that are formed in front-back direction (inner-blade width direction) X in respective side walls 520. With inner-blade slit 570 thus having the ends formed in respective side walls 520 in front-back direction X in the present exemplary embodiment, side walls 520 are subject to suppressed interference from hair H that is introduced sideways into slit 470.

Inner blades 50 are mounted to the drive mechanism (not shown) that is accommodated in head section body 31. As the drive mechanism is driven, inner blades 50 each reciprocate along left-right direction Y.

Inner blades 501 for outer net blades 401, and inner slit blade 500 are mounted to the drive mechanism to be vertically movable in a manner independent from one another. Each of inner blades 50 is disposed below corresponding outer blade 40 for making sliding contact with inner faces 40b of corresponding outer blade 40 when reciprocating along left-right direction Y.

Thus, inner blades 50, that is, inner blades 501 for outer net blades 401, and inner slit blade 500 that are respectively disposed below (inwardly of) outer net blades 401 and outer slit blade 400 cut hair H that is inserted into the blade holes and slits 470 of outer blades 40 in cooperation with respective outer blades 40 by being shifted (reciprocated along left-right direction Y) relatively to respective outer blades 40. It is to be noted that inner slit blade 500 may be mounted to outer-blade cassette 32b so as to reciprocate relative to outer slit blade 400. In other words, outer slit blade 400 and inner slit blade 500 may form a slit blade unit.

Here, outer faces 500a of inner slit blade 500 preferably make resilient contact with inner faces 432 of outer slit blade 400. In this way, satisfactory cutting quality can be ensured when hair H is cut between respective sliding faces (inner face 432 and outer face 500a) of outer slit blade 400 and inner slit blade 500.

In the present exemplary embodiment, flat-lying hair H introduced into slit 470 of outer slit blade 400 is lifted so that efficient shaving is enabled.

Specifically, at least one of two bars 430, 430 that define slit 470 in outer slit blade 400 (outer blade 40) is provided with lifter 60 that lifts, by contact, hair H that is introduced into slit 470.

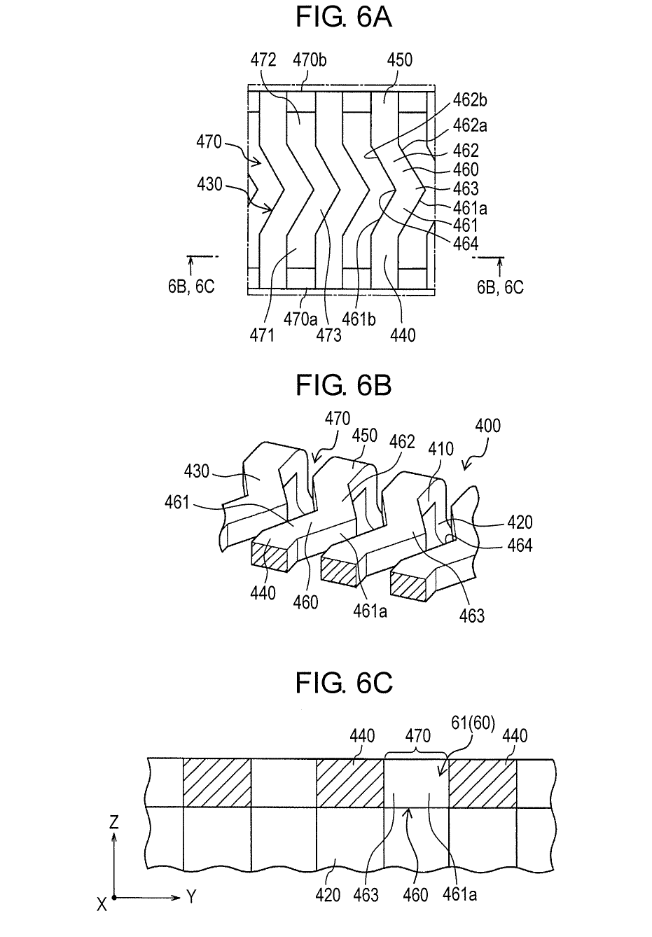

This lifter 60 is formed partway along slit 470 that is defined continuously from first slit end 470a to second slit end 470b along front-back direction (outer-blade width direction) X. When viewed along front-back direction X, lifter 60 (refer to FIG. 6C) extends between the edges of slit 470 along left-right direction (outer-blade length direction) Y.

Based on FIG. 5 and FIGS. 6A to 6C, a detailed description is provided of concrete structure of outer slit blade 400 according to the present exemplary embodiment.

In the present exemplary embodiment, slit 470 is defined, as mentioned above, between two bars 430, 430 that are adjacent along left-right direction (outer-blade length direction) Y of outer slit blade (outer blade) 400. The edges of slit 470 positioned side by side along left-right direction Y are defined by those two bars 430, 430, respectively.

In the present exemplary embodiment, each of bars 430 has such a shape that its midsection positioned in front-back direction X is bent in one direction along left-right direction Y.

Specifically, bar 430 includes first straight bar part 440 that is disposed at one of the ends in front-back direction X to extend along front-back direction X.

Bar 430 further includes second straight bar part 450 that is disposed at the other end in front-back direction X to extend along front-back direction X. In the present exemplary embodiment, when viewed along front-back direction X, first straight bar part 440 is entirely overlapped with second straight bar part 450, and second straight bar part 450 is entirely overlapped with first straight bar part 440. In other words, first straight bar part 440 and second straight bar part 450 are formed in the same position when viewed along front-back direction X.

First straight bar part 440 and second straight bar part 450 are connected by bent bar part 460. Bent bar part 460 is formed to have a substantially V-shape in its plan view (when viewed along up-down direction Z).

Thus, bar 430 is formed of, in the present exemplary embodiment, first straight bar part 440 and second straight bar part 450 that are respectively positioned at the ends in front-back direction (outer-blade width direction) X, and bent bar part 460 that connects first straight bar part 440 and second straight bar part 450.

Bent bar part 460 includes first bending bar part 461 that connects with an end of first straight bar part 440 in front-back direction X and extends in the one direction along left-right direction (outer-blade length direction) Y.

Bent bar part 460 further includes second bending bar part 462 that connects with an end of second straight bar part 450 in front-back direction X, extends in the one direction along left-right direction Y and connects with first bending bar part 461.

By being formed of these first and second bending bar parts 461 and 462, bent bar part 460 is provided with, at its one end in left-right direction Y, projection 463 that projects further in the one direction along left-right direction Y than first and second straight bar parts 440 and 450. This projection 463 is positioned between first-bending-bar-part side face 461a that faces first slit end 470a of slit 470 and second-bending-bar-part side face 462a that faces second slit end 470b of slit 470.

By being formed of first and second bending bar parts 461 and 462, bent bar part 460 is also provided with, at its side opposite to projection 463 along left-right direction (outer-blade length direction) Y, recess 464 that is recessed toward projection 463. This recess 464 is positioned between first-bending-bar-part side face 461b that faces second slit end 470b of slit 470 and second-bending-bar-part side face 462b that faces first slit end 470a of slit 470.

In the present exemplary embodiment, first bending bar part 461 and second bending bar part 462 are each formed to have a substantially uniform width along left-right direction (outer-blade length direction) Y, and their widths along left-right direction Y are each substantially equal to a width of each of first and second straight bar parts 440 and 450 along left-right direction Y.

In the present exemplary embodiment, the plurality of bars 430 thus shaped are arranged with the substantially equal intervals at the predetermined pitches (predetermined intervals) along left-right direction Y.

As such, slit 470 of substantially uniform width along left-right direction Y is defined continuously from first slit end 470a to second slit end 470b between two bars 430, 430 that are adjacent along left-right direction Y.

Specifically, slit 470 includes first straight slit part 471 with first straight bar parts 440 respectively defining edges of first straight slit part 471 positioned side by side along left-right direction (outer-blade length direction) Y.

Slit 470 further includes second straight slit part 472 with second straight bar parts 450 respectively defining edges of second straight slit part 472 positioned side by side along left-right direction Y.

First straight slit part 471 and second straight slit part 472 are connected by bent slit part 473. Bent slit part 473 is formed to have a substantially V-shape in its plan view (when viewed along up-down direction Z) with bent bar parts 460 respectively defining edges of bent slit part 473 positioned side by side along left-right direction Y.

Thus, slit 470 is formed of, in the present exemplary embodiment, first straight slit part 471, second straight slit part 472, and bent slit part 473 that connects first straight slit part 471 and second straight slit part 472.

With bars 430 and slits 470 shaped as described above, one of two bars 430, 430 respectively defining the edges of slit 470 positioned side by side along left-right direction Y is provided with projection 463 that projects into slit 470, while the other one of those two bars 430, 430 respectively defining the edges of slit 470 positioned side by side along left-right direction Y is provided with, in the position corresponding to projection 463, recess 464 that is recessed in the projecting direction of projection 463.

In the present exemplary embodiment, projection 463 thus formed at the one of two adjacent bars 430, 430 corresponds to a one-end projection that projects into slit 470, while recess 464 formed at the other one of those two adjacent bars 430, 430 corresponds to an another-end recess that is recessed in the projecting direction of the one-end projection.

It is to be noted that projection 463 and recess 464 are formed partway along slit 470 that is continuously formed from first slit end 470a to second slit end 470b along front-back direction X.

In the present exemplary embodiment, an amount by which projection 463 projects into first straight slit part 471 when viewed from one of the ends in front-back direction (outer-blade width direction) X and an amount by which projection 463 projects into second straight slit part 472 when viewed from the other end in front-back direction (outer-blade width direction) X are each equal to or more than the width of slit 470 along left-right direction (outer-blade length direction) Y. It is to be noted that in the example illustrated in FIG. 5 and FIGS. 6A to 6C, the amount by which projection 463 projects is equal to the width of slit 470 along left-right direction Y.

Thus, when viewed from the one of the ends in front-back direction X, projection 463 is provided with side face 461a of first bending bar part 461 overlapped with the whole width of slit 470 along left-right direction Y.

When viewed from the other end in front-back direction X, projection 463 is provided with side face 462a of second bending bar part 462 overlapped with the whole width of slit 470 along left-right direction Y.

In the present exemplary embodiment, this projection 463 forms first lifter 61 (refer to FIG. 6C) that extends between the edges of slit 470 along left-right direction Y when viewed along front-back direction X.

FIG. 5 and FIGS. 6A to 6C thus illustrate outer slit blade 400 provided with, as lifters 60, first lifters 61 that are each formed of projection (one-end projection) 463.

By having the above structure, outer slit blade 400 can achieve a functional effect as follows.

With flat-lying hair H introduced into first straight slit part 471, outer slit blade 400 is moved along front-back direction X first. Accordingly, flat-lying hair H comes into contact with projection 463 in the course of its movement from first straight slit part 471 to second straight slit part 472. This flat-lying hair H is lifted by making contact with first lifter 61, which is lifter 60 formed of projection 463, and thus is introduced even further toward inner slit blade 500 from the sliding faces (inner face 432 and outer face 500a). Hair H introduced even further toward inner slit blade 500 from the sliding faces (inner face 432 and outer face 500a) is then cut cooperatively by outer slit blade 400 and inner slit blade 500.

As described above, in the present exemplary embodiment, flat-lying hair H is lifted by contact with first lifter 61, which is lifter 60 formed of projection 463, to be introduced even further toward inner slit blade 500 from the sliding faces (inner face 432 and outer face 500a). In this way, hair H can be shaved more efficiently. It is to be noted that a similar functional effect can also be obtained in cases where flat-lying hair H is introduced into second straight slit part 472.

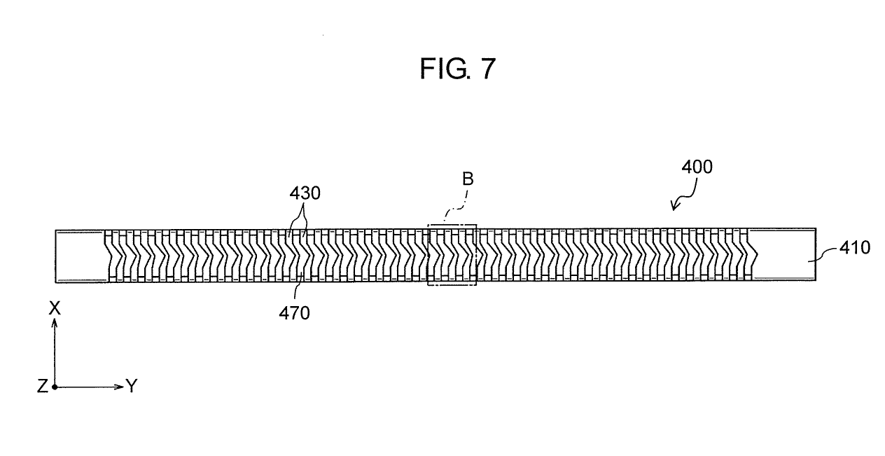

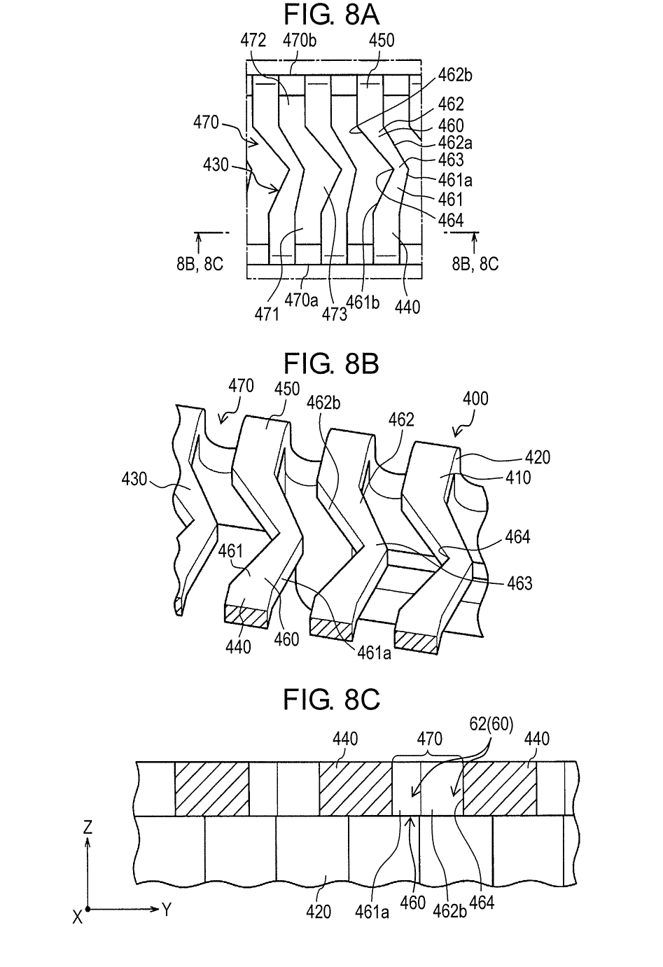

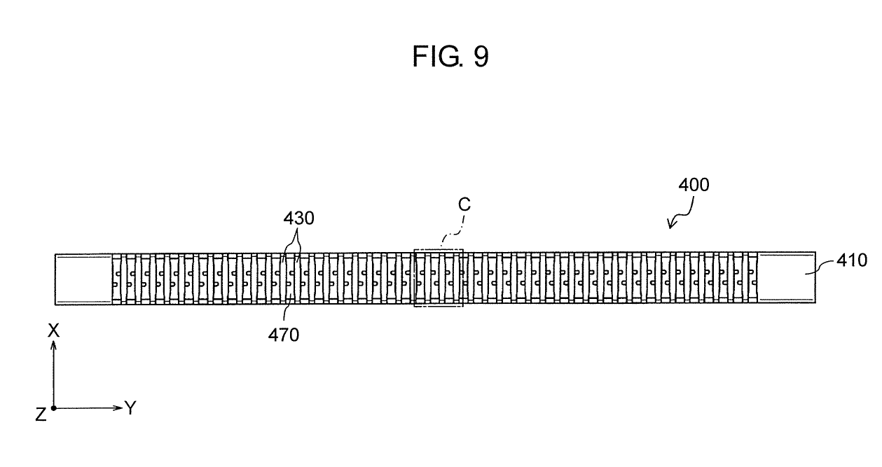

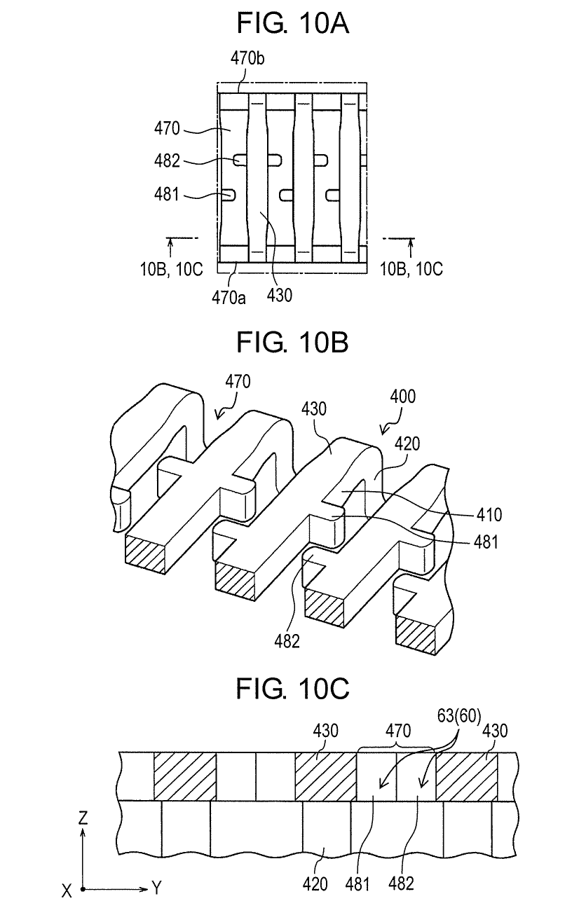

This outer slit blade 400 is not limited to the shape illustrated in FIG. 5 and FIGS. 6A to 6C and can have, for example, a shape illustrated in FIG. 7 and FIGS. 8A to 8C or a shape illustrated in FIG. 9 and FIGS. 10A to 10C.

Outer slit blade 400 illustrated in FIG. 7 and FIGS. 8A to 8C is also provided with slit 470 between two bars 430, 430 that are adjacent along left-right direction (outer-blade length direction) Y. The edges of slit 470 positioned side by side along left-right direction Y are defined by those two bars 430, 430, respectively.

In FIG. 7 and FIGS. 8A to 8C, each of bars 430 has such a shape that its midsection positioned in front-back direction (outer-blade width direction) X is bent in one direction along left-right direction Y.

Specifically, bar 430 includes first straight bar part 440 that is disposed at one of the ends in front-back direction X to extend along front-back direction X. Bar 430 further includes second straight bar part 450 that is disposed at the other end in front-back direction X to extend along front-back direction X.

First straight bar part 440 and second straight bar part 450 are connected by bent bar part 460. Bent bar part 460 is formed to have a substantially V-shape in its plan view (when viewed along up-down direction Z).

Thus, bar 430 is formed of, in FIG. 7 and FIGS. 8A to 8C, first straight bar part 440 and second straight bar part 450 that are respectively positioned at the ends in front-back direction (outer-blade width direction) X, and bent bar part 460 that connects first straight bar part 440 and second straight bar part 450.

Bent bar part 460 includes first bending bar part 461 that connects with an end of first straight bar part 440 in front-back direction X and extends in the one direction along left-right direction (outer-blade length direction) Y.

Bent bar part 460 further includes second bending bar part 462 that connects with an end of second straight bar part 450 in front-back direction X, extends in the one direction along left-right direction Y and connects with first bending bar part 461.

By being formed of these first and second bending bar parts 461 and 462, bent bar part 460 is provided with, at its one end in left-right direction Y, projection 463 that projects further in the one direction along left-right direction Y than first and second straight bar parts 440 and 450. This projection 463 is positioned between first-bending-bar-part side face 461a that faces first slit end 470a of slit 470 and second-bending-bar-part side face 462a that faces second slit end 470b of slit 470.

By being formed of first and second bending bar parts 461 and 462, bent bar part 460 is also provided with, at its side opposite to projection 463 along left-right direction Y, recess 464 that is recessed toward projection 463. This recess 464 is positioned between first-bending-bar-part side face 461b that faces second slit end 470b of slit 470 and second-bending-bar-part side face 462b that faces first slit end 470a of slit 470.

In FIG. 7 and FIGS. 8A to 8C, the shape of bar 430 is such that first straight bar part 440 and second straight bar part 450 are offset from each other along left-right direction (outer-blade length direction) Y. This offset of first straight bar part 440 with respect to second straight bar part 450 along left-right direction Y is set smaller than a pitch (predetermined interval) between adjacent two bars 430, 430. In other words, when viewed along front-back direction X, first straight bar part 440 is partly overlapped with second straight bar part 450, and second straight bar part 450 is partly overlapped with first straight bar part 440.

The concrete shape of bar 430 illustrated in FIG. 7 and FIGS. 8A to 8C is such that second straight bar part 450 is offset in one direction along left-right direction Y with respect to first straight bar part 440 by an amount smaller than one pitch (for example, by one-half the pitch). As such, when viewed from the one of the ends in front-back direction (outer-blade width direction) X, side face 462b of second bending bar part 462 is partly in a position where second straight bar part 450 is offset from first straight bar part 440 in FIG. 7 and FIGS. 8A to 8C. This means that when viewed from one side in front-back direction X, side face 462b of second bending bar part 462 is partly exposed in slit 470.

In FIG. 7 and FIGS. 8A to 8C, first bending bar part 461 is formed so that its width along left-right direction Y reduces in a direction away from first straight bar part 440 along front-back direction X. Moreover, second bending bar part 462 is formed so that its width along left-right direction Y reduces in a direction away from second straight bar part 450 along front-back direction X.

In FIG. 7 and FIGS. 8A to 8C, the plurality of bars 430 thus shaped are arranged with substantially equal intervals at predetermined pitches (predetermined intervals) along left-right direction (outer-blade length direction) Y.

As such, slit 470 is defined continuously from first slit end 470a to second slit end 470b between two bars 430, 430 that are adjacent along left-right direction Y. A width of this slit 470 along left-right direction Y is greater at a slit midsection positioned in front-back direction X.

Slit 470 includes first straight slit part 471 with first straight bar parts 440 respectively defining edges of first straight slit part 471 positioned side by side along left-right direction Y.

Slit 470 further includes second straight slit part 472 with second straight bar parts 450 respectively defining edges of second straight slit part 472 positioned side by side along left-right direction Y.

First straight slit part 471 and second straight slit part 472 are connected by bent slit part 473. Bent slit part 473 is formed to have a substantially V-shape in its plan view (when viewed along up-down direction Z) with bent bar parts 460 respectively defining edges of bent slit part 473 positioned side by side along left-right direction Y.

Thus, slit 470 is formed of, in FIG. 7 and FIGS. 8A to 8C, first straight slit part 471, second straight slit part 472, and bent slit part 473 that connects first straight slit part 471 and second straight slit part 472.

With bars 430 and slits 470 shaped as described above, one of two bars 430, 430 respectively defining the edges of slit 470 positioned side by side along left-right direction Y is provided with projection 463 that projects into slit 470, while the other one of those two bars 430, 430 respectively defining the edges of slit 470 positioned side by side along left-right direction Y is provided with, in the position corresponding to projection 463, recess 464 that is recessed in the projecting direction of projection 463.

In FIG. 7 and FIGS. 8A to 8C, projection 463 thus formed at the one of two adjacent bars 430, 430 corresponds to a one-end projection that projects into slit 470, while recess 464 formed at the other one of those two adjacent bars 430, 430 corresponds to an another-end recess that is recessed in the projecting direction of the one-end projection.

It is to be noted that projection 463 and recess 464 are formed partway along slit 470 that is continuously formed from first slit end 470a to second slit end 470b along front-back direction X.

In FIG. 7 and FIGS. 8A to 8C, an amount by which projection 463 projects into first straight slit part 471 when viewed from the one of the ends in front-back direction (outer-blade width direction) X is less than the width of slit 470 along left-right direction (outer-blade length direction) Y. Specifically, when viewed from the one of the ends in front-back direction X, projection 463 formed projects along left-right direction Y to reach a position between the end of second straight bar part 450 of adjacent bar 430 located in the projecting direction of projection 463 and the end of first straight bar part 440 of that adjacent bar 430. It is to be noted that in the example illustrated in FIG. 7 and FIGS. 8A to 8C, projection 463 projects along left-right direction Y to reach the end of second straight bar part 450 of adjacent bar 430 located in the projecting direction of projection 463.

When viewed from the one of the ends in front-back direction X, side face 461a of first bending bar part 461 and the part of side face 462b of second bending bar part 462 cover the whole width of slit 470 along left-right direction Y.

Thus, lifter 60 that is formed of projection 463 and recess 464 is formed as second lifter 62. This second lifter 62 also extends between the edges of slit 470 along left-right direction Y when viewed along front-back direction X.

FIG. 7 and FIGS. 8A to 8C thus illustrate outer slit blade 400 having second lifters 62 as lifters 60 that are each formed of projection (one-end projection) 463 and recess (another-end recess) 464.

By having the above structure, outer slit blade 400 can achieve a functional effect as follows.

With flat-lying hair H introduced into first straight slit part 471, outer slit blade 400 is moved along front-back direction X first. Accordingly, flat-lying hair H comes into contact with projection 463 and recess 464 in the course of its movement from first straight slit part 471 to second straight slit part 472. This flat-lying hair H is lifted by making contact with second lifter 62, which is lifter 60 formed of projection 463 and recess 464, and thus is introduced even further toward inner slit blade 500 from sliding faces (inner face 432 and outer face 500a) (refer to FIG. 4). Hair H introduced even further toward inner slit blade 500 from the sliding faces (inner face 432 and outer face 500a) is then cut cooperatively by outer slit blade 400 and inner slit blade 500.

As described above, flat-lying hair H is lifted by contact with second lifter 62, which is lifter 60 formed of projection 463 and recess 464, to be introduced even further toward inner slit blade 500 from the sliding faces (inner face 432 and outer face 500a). In this way, hair H can be shaved more efficiently.

In outer slit blade 400 illustrated in FIG. 7 and FIGS. 8A to 8C, when viewed from second slit end 470b along front-back direction X, the whole width of slit 470 along left-right direction Y is covered by side face 462a of second bending bar part 462.

Accordingly, a functional effect similar to that of outer slit blade 400 illustrated in FIG. 5 and FIGS. 6A to 6C is obtained in cases where flat-lying hair H is introduced into second straight slit part 472.

Outer slit blade 400 illustrated in FIG. 9 and FIGS. 10A to 10C is also provided with slit 470 between two bars 430, 430 that are adjacent along left-right direction (outer-blade length direction) Y. The edges of slit 470 positioned side by side along left-right direction Y are defined by those two bars 430, 430, respectively.

Bars 430 illustrated in FIG. 9 and FIGS. 10A to 10C are of substantially straight shape, extending along front-back direction (outer-blade width direction) X.

In FIG. 9 and FIGS. 10A to 10C, the plurality of bars 430 thus shaped are arranged with substantially equal intervals at predetermined pitches (predetermined intervals) along left-right direction Y.

In FIG. 9 and FIGS. 10A to 10C, one of two bars 430, 430 respectively defining the edges of slit 470 positioned side by side along left-right direction Y is provided with projection (one-end projection) 481 that projects in one direction along left-right direction Y (into slit 470), while the other one of those two bars 430, 430 respectively defining the edges of slit 470 positioned side by side along left-right direction Y is provided with projection (another-end projection) 482 that projects in the other direction along left-right direction Y (into slit 470). When viewed along left-right direction Y, projection (another-end projection) 482 is spaced away from projection (one-end projection) 481 along front-back direction X.

In FIG. 9 and FIGS. 10A to 10C, an amount by which projection (one-end projection) 481 projects in the one direction along left-right direction Y is smaller than one pitch (e.g., one-half the pitch). Moreover, an amount by which projection (another-end projection) 482 projects in the other direction along left-right direction Y is smaller than one pitch (for example, one-half the pitch).

As such, slit 470 of substantially uniform width along left-right direction Y is defined continuously from first slit end 470a to second slit end 470b between two bars 430, 430 that are adjacent along left-right direction Y.

When viewed along front-back direction (outer-blade width direction) X in FIG. 9 and FIGS. 10A to 10C, projection (one-end projection) 481 and projection (another-end projection) 482 cover the whole width of slit 470 along left-right direction (outer-blade length direction) Y.

Thus, lifter 60 that is formed of projection (one-end projection) 481 and projection (another-end projection) 482 is formed as third lifter 63. This third lifter 63 also extends between the edges of slit 470 along left-right direction Y when viewed along front-back direction X.

FIG. 9 and FIGS. 10A to 10C thus illustrate outer slit blade 400 having third lifters 63 as lifters 60 that are each formed of projection (one-end projection) 481 and projection (another-end projection) 482.

By having the above structure, outer slit blade 400 can achieve a functional effect as follows.

With flat-lying hair H introduced into one of ends 470a, 470b of slit 470 along front-back direction X, outer slit blade 400 is moved along front-back direction X first. Accordingly, flat-lying hair H comes into contact with projection 481 and projection 482 in the course of its movement from the one of ends 470a, 470b of slit 470 to the other one of ends 470a, 470b along front-back direction X. This flat-lying hair H is lifted by making contact with projection 481 and projection 482 that form third lifter 63, which is lifter 60, and thus is introduced even further toward inner slit blade 500 from sliding faces (inner face 432 and outer face 500a) (refer to FIG. 4). Hair H introduced even further toward inner slit blade 500 from the sliding faces (inner face 432 and outer face 500a) is then cut cooperatively by outer slit blade 400 and inner slit blade 500.

As described above, flat-lying hair H is lifted by contact with projection 481 and projection 482 that form third lifter 63, which is lifter 60, to be introduced even further toward inner slit blade 500 from the sliding faces (inner face 432 and outer face 500a). In this way, hair H can be shaved more efficiently.

It is to be noted that a similar functional effect can also be obtained in cases where flat-lying hair H is introduced into the other one of ends 470a, 470b of slit 470 along front-back direction X.

Bars 430 of above-described outer slit blade 400 are each formed to have a substantially quadrangular section taken along a plane (Y-Z plane) that is parallel to up-down direction Z and orthogonal to the direction in which bars 430 extend (refer to FIG. 4). In other words, each of bars 430 includes skin contact face (outer face) 431 that makes contact with skin (skin surface) S, inner face 432 that faces inner slit blade 500 below (on a side opposite to) skin contact face (outer face) 431, and side faces 433 that connect skin contact face (outer face) 431 and inner face 432. Skin-contact-face-side ends 434 and inner-face-side ends 435 of bar 430 each have a substantially right-angled edge (corner).

While flat-lying hair H can be lifted by use of these bars 430 of substantially quadrangular section, it is preferable that hair raising performance of outer slit blade 400 be increased further.

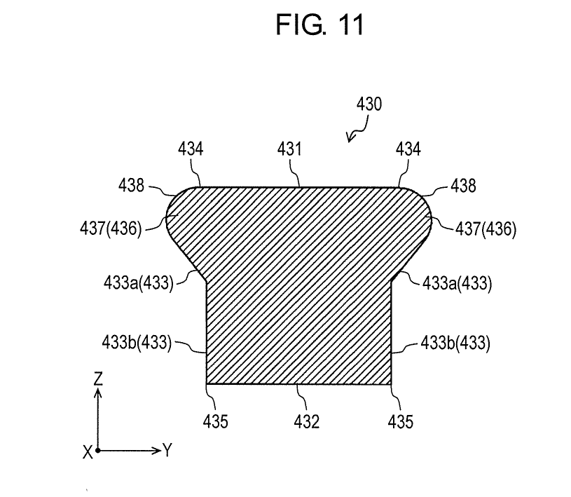

For example, with a section (taken along a plane (Y-Z plane) that is parallel to up-down direction Z and orthogonal to the direction in which bars 430 extend) of bar 430 being of FIG. 11 shape, the hair raising performance of outer slit blade 400 can be increased further.

Bar 430 shown in FIG. 11 is defined by substantially flat skin contact face 431 that makes contact with skin S, substantially flat inner face 432 that faces inner slit blade 500 on a side opposite to skin contact face 431, and side faces 433 that connect skin contact face 431 and inner face 432. In FIG. 11, each of side faces 433 is formed of vertical face 433b that is positioned on its lower side and extends along up-down direction Z, and inclined face 433a that connects with an upper edge of vertical face 433b and is inclined upwardly and outwardly (toward slit 470).

Bar 430 shown in FIG. 11 thus has such a polygonal cross section that an upper part of substantially trapezoidal shape connects with a lower part of substantially rectangular shape with skin contact face 431 being longer than inner face 432.

With such a shape, skin-contact-face-side ends 434 are each provided with acute-angled part 436 as hair raising part 437 in FIG. 11.

Here, because the lower part of bar 430 is substantially rectangular, inner-face-side ends 435 of bar 430 each have a substantially right-angled corner.

This means that an angle formed by inner face 432 of bar 430 and the part (vertical face 433b) of side face 433 of bar 430 is 90°, or equal to or more than 90° in FIG. 11.

With bar 430 having a shape shown in FIG. 11, outer slit blade 400 can have its hair raising performance further increased because of hair raising parts 437 that are formed to project outwardly of respective inner-face-side ends 435.

With inner-face-side ends 435 of bar 430 each having the angle of not less than 90° as shown in FIG. 11, outward projection of inner-face-side ends 435 is suppressed, thus leading to suppressed collision of hair H with inner-face-side ends 435. Consequently, inner-face-side ends 435 can have their obstruction suppressed when hair H is introduced even further toward inner slit blade 500 from the sliding faces (inner face 432 and outer face 500a). As such, hair H can be smoothly introduced even further toward inner slit blade 500 from the sliding faces (inner face 432 and outer face 500a).

Bar 430 shown in FIG. 11 is provided with round portion 438 along an edge of each of hair raising parts 437, thereby enabling a suppressed effect on skin S. To achieve the suppressed effect on skin S with the hair raising performance being delivered, round portion 438 preferably has a curvature radius of not less than 20 μm and not more than 60 μm (when viewed in cross section of bar 430 that is taken orthogonally to the direction in which bar 430 extends).

It is to be noted that FIG. 11 shows the cross-sectional shape of bar 430 merely as one example, and there are various cross-sectional shapes that can be adopted for bar 430.

In above-described outer slit blade 400, the structure having only one lifter 60 is given as an example; however, the structure can have a plurality of lifters 60 formed along front-back direction (outer-blade width direction) X.

Formation of the plurality of lifters 60 along front-back direction X can be achieved by, for example, bar 430 having such a shape that its plurality of parts in front-back direction X are bent in one direction along left-right direction Y.

Formation of the plurality of lifters 60 along front-back direction X can be achieved by formation of a plurality of projections (one-end projections) 481 that project in one direction along left-right direction Y on one of two slit defining bars 430, 430 and formation of a plurality of projections (another-end projections) 482 that project in other direction along left-right direction Y on the other one of those bars 430, 430.

As described above, electric shaver 10 according to the present exemplary embodiment includes outer slit blade 400 (outer blade 40) that has the predetermined length and the predetermined width and makes contact with skin S, and inner slit blade 500 (inner blade 50) that is disposed on a side of outer slit blade 400 (outer blade 40) opposite to the skin S contact side of outer slit blade 400 (outer blade 40) and shifts relatively to outer slit blade 400 (outer blade 40).

Outer slit blade 400 is provided with the plurality of bars 430 that extend along front-back direction (outer-blade width direction) X and are arranged at the predetermined intervals along left-right direction (outer-blade length direction) Y.

Slit 470 into which hair H is introduced is defined between two bars 430, 430 that are adjacent along left-right direction Y with its edges positioned side by side along left-right direction Y being defined by those two bars 430, 430, respectively.

The at least one of two bars 430, 430 is provided with lifter 60 that lifts, by contact, hair H that is introduced into slit 470 as outer slit blade 400 is moved relatively to hair H along front-back direction (outer-blade width direction) X.

Lifter 60 is formed partway along slit 470 that is continuously defined from first slit end 470a to second slit end 470b along front-back direction X and extends between the edges of slit 470 along left-right direction Y when viewed along front-back direction X.

Thus, when outer slit blade 400 is moved along front-back direction X with flat-lying hair H introduced into slit 470, this flat-lying hair H can be brought into abutment with lifter 60, thereby being lifted (raised). In other words, flat-lying hair H is raised and thus can be introduced even further toward inner slit blade 500 from a surface of contact between inner slit blade 500 and outer slit blade 400, that is, from the position where hair H is cut by inner slit blade 500 and outer slit blade 400. Consequently, hair H can be shaved more efficiently.

The one of two bars 430, 430 respectively defining the edges of slit 470 positioned side by side along left-right direction Y can be provided with projection (one-end projection) 463 that projects into slit 470. Moreover, the other one of those two bars 430, 430 can be provided with, in the position corresponding to projection (one-end projection) 463, recess (another-end recess) 464 that is recessed in the projecting direction of projection (one-end projection) 463.

Structurally, lifter 60 can include first lifter 61 that is formed of projection (one-end projection) 463.

Structurally, lifter 60 can include second lifter 62 that is formed of projection (one-end projection) 463 and recess (another-end recess) 464.

The one of two bars 430, 430 respectively defining the edges of slit 470 positioned side by side along left-right direction Y can be provided with projection (one-end projection) 481 that projects into slit 470. Moreover, the other one of those two bars 430, 430 can be provided with projection (another-end projection) 482 that is spaced away from projection (one-end projection) 481 along front-back direction X and projects into slit 470. Structurally, lifter 60 can include third lifter 63 that is formed of projection (one-end projection) 481 and projection (another-end projection) 482.

In this way, outer slit blade 400 that can shave hair H more efficiently can be of more simplified structure.

The plurality of lifters 60 can be formed along front-back direction X.

Thus, when outer slit blade 400 is moved along front-back direction X with flat-lying hair H introduced into slit 470, opportunities for flat-lying hair H to be lifted can be increased. Consequently, hair H can be shaved even more efficiently.

Outer slit blade 400 is used in electric shaver 10.

The use of this outer slit blade 400 enables more efficient shaving of hair H.

The preferred exemplary embodiment of the present disclosure has been described above. However, the present disclosure is not limited to the above exemplary embodiment and various modifications are possible.

While the electric shaver including the grip section and the head section is given as an example in the above exemplary embodiment, the present disclosure can be applied to, for example, an electric shaver with no head section.

The inner slit blade and the outer slit blade can operate together with, for example, an outer net blade, a trimmer blade, a beard lifting comb, and a roller.

In the above exemplary embodiment, the plural kinds of slits of different planar shapes are given as examples; however, the slit is not limited to these shapes. There are other various planar shapes that can be adopted for the slit. In the above exemplary embodiment, the plural kinds of bars of different cross-sectional shapes are given as examples; however, the bar is not limited to these shapes. There are other various cross-sectional shapes that can be adopted for the bar.

The outer blade has slits of the predetermined planar shape and bars of the predetermined cross-sectional shape. The slit having a planar shape of choice and the bar having a cross-sectional shape of choice can be combined. For example, the slit can be of FIG. 6A planar shape, while the bar can be of FIG. 11 cross-sectional shape.

Also, specifications (including shape, size, and layout) of the outer blades, the inner blades, and other details can be appropriately changed.

As described above, the electric shaver according to the first aspect of the disclosure includes the outer blade that has the predetermined length and the predetermined width and makes contact with skin, and the inner blade that is disposed on the side of the outer blade opposite to the skin contact side of the outer blade and shifts relatively to the outer blade.

The outer blade is provided with the plurality of bars that extend along the outer-blade width direction and are arranged at the predetermined intervals along the outer-blade length direction.

The slit into which hair is introduced is defined, between two of the bars that are adjacent along the outer-blade length direction, by respective ends of the two bars, the respective ends being positioned side by side along the outer-blade length direction. The slit is continuously defined from one end to another end in the outer-blade width direction.

The at least one of the two bars is provided with the lifter that lifts, by contact, the hair that is introduced into the slit as the outer blade is moved relatively to the hair along the outer-blade width direction.

The lifter is formed partway along the slit and extends between edges of the slit along the outer-blade length direction when viewed along the outer-blade width direction.

With such a structure, when the outer blade is moved along the outer-blade width direction with flat-lying hair introduced into the slit, the flat-lying hair can be brought into abutment with the lifter, thereby being lifted (raised). As such, the flat-lying hair is raised and thus can be introduced even further toward the inner blade from the surface of contact between the inner blade and the outer blade, that is, from the position where the hair is cut by the inner blade and the outer blade. Consequently, hair can be shaved more efficiently.

The electric shaver according to the second aspect of the disclosure is based on the first aspect of the disclosure and is such that the one of the two bars respectively defining the edges of the slit is provided with a one-end projection that projects into the slit, the edges being positioned side by side along the outer-blade length direction, another of the two bars is provided with, in a position corresponding to the one-end projection, an another-end recess that is recessed in a projecting direction of the one-end projection, and the lifter includes a first lifter that is formed of the one-end projection.

Structurally, the lifter can include the second lifter that is formed of the one-end projection and the another-end recess.

Alternatively, the one of the two bars respectively defining the edges of the slit can be provided with a one-end projection that projects into the slit, the edges being positioned side by side along the outer-blade length direction, another of the two bars can be provided with an another-end projection that is spaced away from the one-end projection along the outer-blade width direction and projects into the slit, and the lifter can include a third lifter that is formed of the one-end projection and the another-end projection.

In this way, the outer blade that can shave hair more efficiently can have more simplified structure.

The plurality of lifters can be formed along the outer-blade width direction.

Thus, when the outer blade is moved along the outer-blade width direction with flat-lying hair introduced into the slit, opportunities for the flat-lying hair to be lifted can be increased, so that hair can be shaved even more efficiently.

The outer blade is used in the electric shaver.

The use of this outer blade enables more efficient shaving of hair. According to the present disclosure, an electric shaver that can shave hair more efficiently, and an outer blade that is used in the electric shaver can be obtained.

What is claimed is:

1. An electric shaver comprising:
an outer blade that makes contact with skin, the outer blade having a predetermined length and a predetermined width; and
an inner blade that shifts relatively to the outer blade, the inner blade being disposed on a side of the outer blade opposite to a skin contact side of the outer blade,
wherein the outer blade is provided with a plurality of bars that extend along an outer-blade width direction and are arranged at predetermined intervals along an outer-blade length direction,
a slit into which hair is introduced is defined, between two of the plurality of bars that are adjacent along the outer-blade length direction, by respective ends of the two bars, the respective ends being positioned side by side along the outer-blade length direction, the slit being continuously defined from one end to another end in the outer-blade width direction,
at least one of the two bars is provided with a lifter that lifts, by contact, the hair that is introduced into the slit as the outer blade is moved relatively to the hair along the outer-blade width direction, and
the lifter is formed partway along the slit and extends between the edges of the slit along the outer-blade length direction when viewed along the outer-blade width direction.

2. The electric shaver according to claim 1, wherein
one of the two bars respectively defining the edges of the slit is provided with a one-end projection that projects into the slit, the edges being positioned side by side along the outer-blade length direction;
another of the two bars is provided with, in a position corresponding to the one-end projection, an another-end recess that is recessed in a projecting direction of the one-end projection; and
the lifter includes a first lifter that is formed of the one-end projection.

3. The electric shaver according to claim 1, wherein
one of the two bars respectively defining the edges of the slit is provided with a one-end projection that projects into the slit, the edges being positioned side by side along the outer-blade length direction;
another of the two bars is provided with, in a position corresponding to the one-end projection, an another-end recess that is recessed in a projecting direction of the one-end projection; and
the lifter includes a second lifter that is formed of the one-end projection and a third lifter that is formed of the another-end recess.

4. The electric shaver according to claim 1, wherein
one of the two bars respectively defining the edges of the slit is provided with a one-end projection that projects into the slit, the edges being positioned side by side along the outer-blade length direction;
another of the two bars is provided with an another-end projection that is spaced away from the one-end projection along the outer-blade width direction and projects into the slit; and
the lifter includes a fourth lifter that is formed of the one-end projection and a fifth lifter that is formed of the another-end projection.

5. The electric shaver according to claim 1, wherein a plurality of the lifters are formed along the outer-blade width direction.

6. An outer blade that is used in the electric shaver according to claim 1.
